(19) United States
(12) Patent Application Publication
(10) Pub. No.: US 2015/0172680 A1
(43) Pub. Date: Jun. 18, 2015

(54) Producing an Output Need Parameter for an Encoder

(71) Applicant: ARRIS Enterprises, Inc., Suwanee, GA (US)

(72) Inventors: Wei Zhou, Milpitas, CA (US); Venkatram Vajjhula, Fremont, CA (US); Wayne D. Michelsen, Santa Clara, CA (US)

(21) Appl. No.: 14/571,636

(22) Filed: Dec. 16, 2014

Related U.S. Application Data
(60) Provisional application No. 61/916,662, filed on Dec. 16, 2013.

(51) Int. Cl. H04N 19/196; H04N 19/40; H04N 19/172; H04N 19/154; H04N 19/14; H04N 19/115

(52) U.S. Cl. CPC H04N 19/196; H04N 19/14; H04N 19/115; H04N 19/172; H04N 19/198; H04N 19/154; H04N 19/40

(57) ABSTRACT

A target bit rate determination model is provided that allows information from a look ahead encoder or a decoder to be used to produce a need parameter for an encoder. Two ways to control an encoder system are provided. In the first control method, statistics from a look ahead encoder and knowledge of bitrate requirements for different codecs are used to create a need parameter control input for the primary encoder. In the second method, statistics from a decoder and knowledge of decoder and encoder behavior are used to create a need parameter control input for the primary encoder.

### CROSS REFERENCE TO RELATED APPLICATION

This Application claims priority under 35 U.S.C. §119(e) from earlier filed U.S. Provisional Application Ser. No. 61/916,662 filed on Dec. 16, 2013 and incorporated herein by reference in its entirety.

### BACKGROUND

1. Technical Field

The present invention relates to a system for determining an output need parameter for an encoder.

2. Related Art

Video encoders compress video into a coded bitstream in order to save bandwidth. In general, if a constant quality bitstream is needed, more bits will be required for complex video, leading to a variable bitrate (VBR). For a constant bit rate (CBR) stream, the quantization parameters are varied in response to a rate-control feedback system and the quality will vary accordingly. A constant fidelity constant bit rate (CFCBR) system has been described that is a hybrid of VBR/CBR, where the encoder will not produce a bit rate greater than a predetermined bit rate and also it will not produce video having a quality greater than a predetermined threshold. Similar concepts for adaptive bitrate streaming (ABR) and constant fidelity adaptive bitrate (CFABR) streaming have also been described.

It is desirable to provide a system that can improve these video compression techniques for encoding.

### SUMMARY

Embodiments of the present invention provide a bit rate determination model that allows information from a look ahead encoder or a decoder to be used to produce a need parameter for an encoder. Two new ways to control need parameter for an encoder system are described. In the first control method, statistics from a look ahead encoder and knowledge of bitrate requirements for different codecs are used to create a need parameter control input for the primary encoder. In the second method, statistics from a decoder and knowledge of decoder and encoder behavior are used to create a need parameter control input for the primary encoder.

In one embodiment, a dual pass encoder system is provided comprising: a primary encoder receiving raw video frames from the system input and providing a compressed video output; a lookahead encoder receiving the raw video frames provided to the input to the primary encoder; and a need parameter model module that receives a complexity value output from the lookahead encoder, maps the complexity to a need parameter value, and provides the need parameter value to the primary encoder. In a further embodiment, a decoder is provided in the system that supplies compressed video to both the primary encoder and the lookahead encoder.

In a further embodiment, the lookahead encoder is not used, and a transcoder system is provided. The transcoding system comprises: a decoder receiving a compressed video input; a encoder receiving raw video frames from the output of the decoder, the encoder providing a compressed video output; a complexity normalization module receiving a complexity value output from an output of the decoder; a need parameter model module that a normalized complexity value output from the complexity normalization module, maps the complexity to a need parameter value, and provides the need parameter value as a first bitrate output value; and a bitrate conversion module receiving the first bitrate from the need parameter module and converting to a second bitrate to provide to the encoder.

In the transcoding system, the complexity normalization module determines the complexity values using the following steps: selecting numerous videos of different contents that cover different levels of complexities; first encoding the numerous videos using a pre-determined bitrate; determining the complexities of the numerous first encoded videos; second encoding the videos at various bitrates; plotting for each different video a complexity to bitrate used in the second encoding to form a mapping of complexity to bitrate; and determining from a curve of the plotting the normalized complexity output from the video received.

### BRIEF DESCRIPTION OF THE DRAWINGS

Further details of the present invention are explained with the help of the attached drawings in which:

FIG. 1 shows a dual pass encoder system according to an embodiment of the present invention with a lookahead encoder that enables a need parameter value to be created to control the primary encoder;

FIG. 2 shows a system with a lookahead encoder used to provide a need parameter for a primary encoder, wherein a decoder provides the raw video frame input to the lookahead encoder and primary encoder;

FIG. 3 shows a transcoder system where there is no lookahead encoder, just a single pass encoder;

FIG. 4 shows modifications primarily to the system where in order to achieve smooth bitrate allocation in the encoder, an extra delay buffer queue is added;

FIG. 5 shows a relationship, B=func(X), between complexity and bitrate used to control a primary encoder from a lookahead encoder; and

FIG. 6 provides an empirical relationship, B=func(X_PRED), between complexity and bitrate used to control the primary encoder from the decoder.

### DETAILED DESCRIPTION

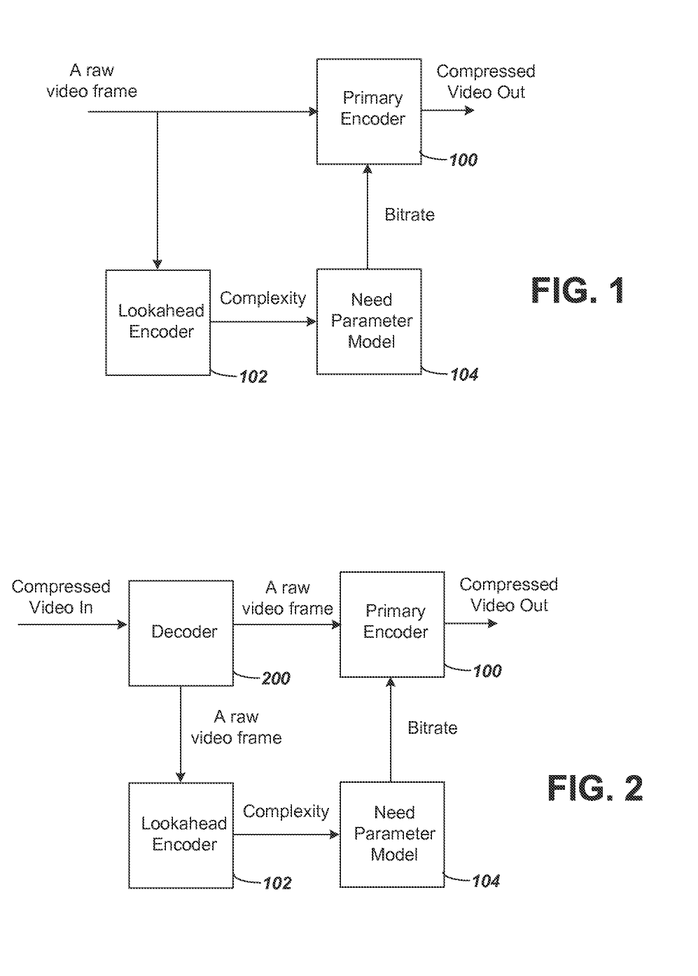

FIG. 1 shows a dual pass encoder system according to an embodiment of the present invention with a lookahead encoder 102 that encodes the raw video in the same format as the primary encoder 100. The lookahead encoder 102 operates at a pre-determined bit rate. The lookahead enables a need parameter value to be created to control the primary encoder. A complexity value is extracted by the lookahead encoder 102. The complexity estimation can be based on spatial detail measurements, correlation of motion vectors, quantization parameters, number of coded bits, color detail, buffer fullness or other statistical measurements. A need parameter model 104 has been developed relating the complexity of the lookahead encoder 102 to a need parameter that controls the primary encoder 100. One example of a need parameter is target video bitrate. The model 104 maps complexity to the target bitrate. The model 104 can be an empirical model, a lookup table or a mathematical relationship between the lookahead complexity and need parameter for the primary encoder.

FIG. 2 shows a system with a lookahead encoder 102 used to provide a need parameter for a primary encoder 100, in a system wherein a decoder 200 provides the raw video frame input to the lookahead encoder 102 and primary encoder 100. In a transcoder system, a decoder and encoder may be used to convert an incoming bitstream at bit rate B1 to an outgoing bitstream at bit rate B2, where the incoming and outgoing bitstreams may be coded for the same codec or a different codec. The incoming bitstream may be a transport stream or an elementary stream. In the system shown in FIG. 2, after decoding, a lookahead encoder 102 encodes the raw video in the same format as the primary encoder 100 at the pre-determined bit rate. In the same way as in FIG. 1, a complexity value is extracted from the lookahead encoder statistics and used to generate a need parameter model. For components carried over from FIG. 1 to FIG. 2, similar reference numbers as will be components carried over into subsequent figures.

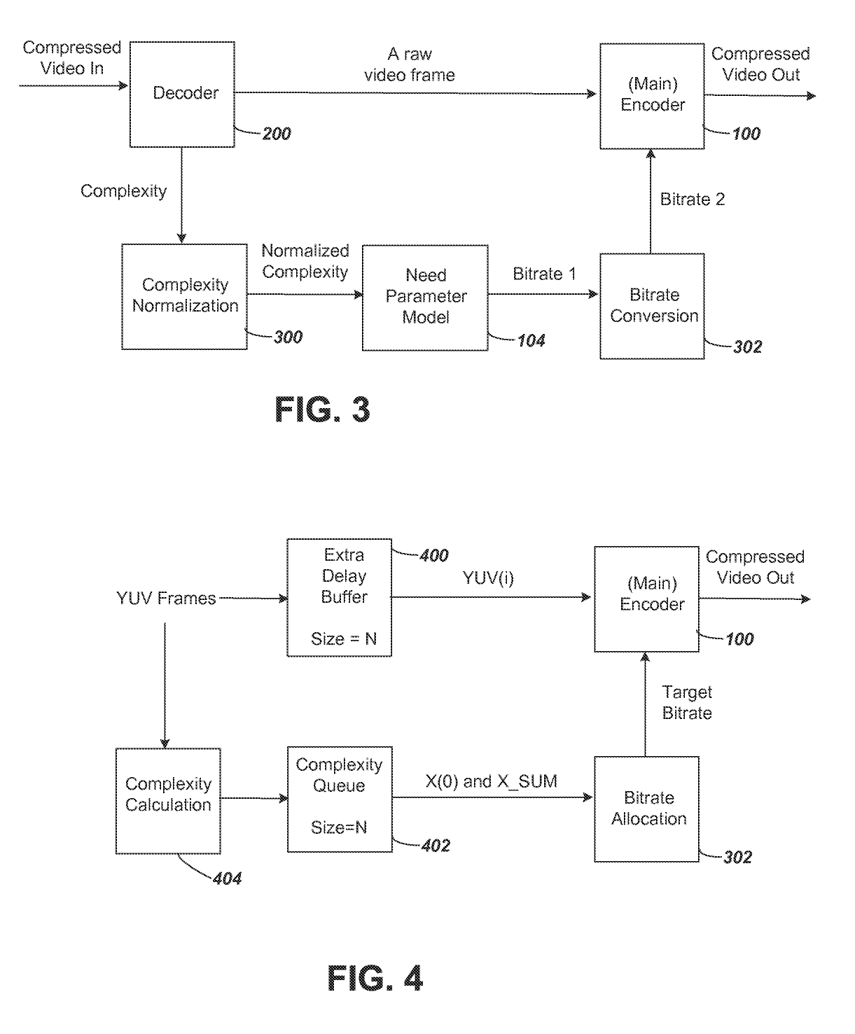

FIG. 3 shows a transcoder system, including a decoder 200 and single pass encoder 100 carried over from the systems depicted in FIGS. 1 and 2. In a system with a lookahead encoder 102 as in FIGS. 1-2, the complexity is computed from the lookahead encoder 102. In this case of FIG. 3, no lookahead buffer 102 is provided and the bitrate of the input video can be different from the pre-determined bitrate which a lookahead encoder operates. But a complexity computation can be based on the statistics extracted from the decoder 200 such as motion vectors, quantization parameters, coded block pattern values, number of coded bits or other metrics. Therefore, a new model is needed that can relate the complexity from the decoder 200 to a need parameter for the encoder 100. Note that the encoder 100 is labeled (main) encoder rather than primary encoder, as there is no secondary encoder used in FIG. 3, and the same labeling will be used in subsequent figures when no secondary encoder is used. In FIG. 3, the model is provided with a complexity normalization element 300 that normalizes the complexity from the decoder 200 to a value that would have been produced by a lookahead encoder operating at the pre-determined bitrate The normalized complexity is used to generate the normalized complexity for a need parameter model 104 as before, and then if the codecs are of a different type, a bitrate conversion stage element 302 is introduced that maps the required bitrate from one codec type to another, based upon a model that can be an empirical model, a lookup table or a mathematical relationship.

FIG. 4 shows modifications primarily to the system of FIG. 1, but also to the systems of FIGS. 2 and 3, where in order to achieve smooth bitrate allocation in the encoder, an extra delay buffer queue 400 is added. A comparable complexity queue 402 if further created to stack complexity determinations that match the frames in buffer 400. A complexity calculation module 404 provides complexity determinations to the complexity queue 402. The average complexity determined in module 404 that is provided to the complexity queue 402 as well as the complexity of each frame is used to adjust the need parameter using a sliding window, thus avoiding spikes in bitrate.

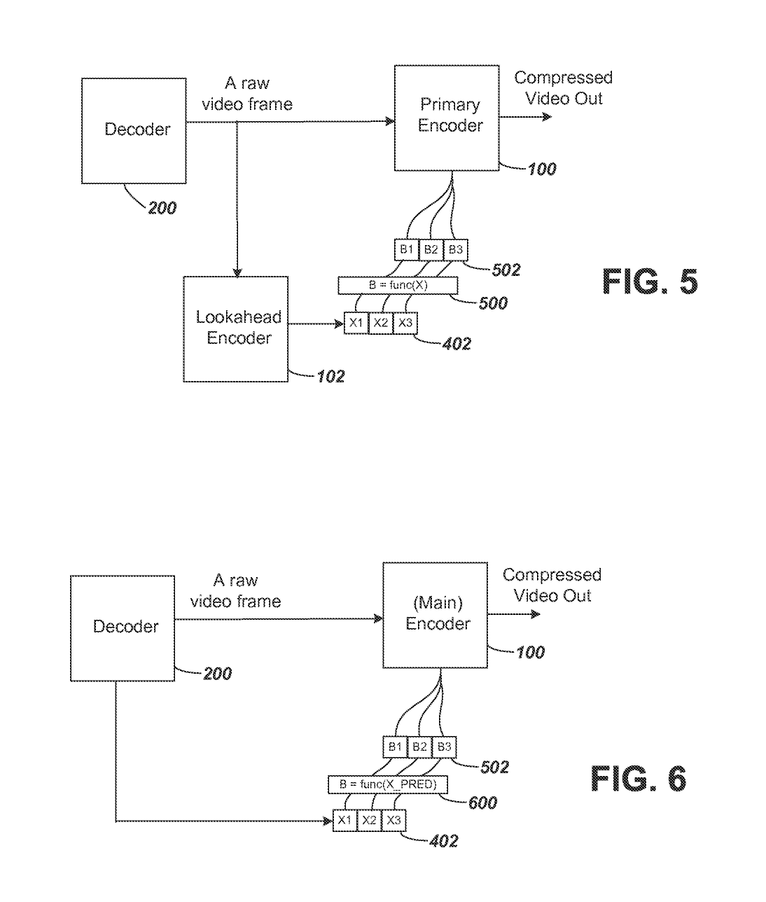

FIG. 5 shows an empirical relationship, B=func(X), labeled 500 between the complexity queue 402 and bitrate queue used to control a primary encoder 100 from a lookahead encoder 102. The function is applied to complexity values from the complexity queue 402 and the output of the function is provided into the bitrate queue 502 that is part of the bitrate allocation module 302 provides bitrate values to the primary encoder 100. This empirical relationship between the complexity and bitrate is determined using an experimental process. First, numerous videos of different contents that cover all levels of complexities are selected. They are then encoded using the pre-determined bitrate based on their resolutions, frame rates and other attributes. The complexities of the videos are obtained in this manner. Second, each of the videos is encoded at various bitrates from very low to very high. To select a desirable bitrate, the video quality of the videos at different bitrates is assessed subjectively by a group of viewers. The lowest bitrate that delivers better video quality than the predetermined quality threshold is picked as the need parameter for encoding videos that have the same level of complexity of the video determined in the first step. This step will be repeated for all the selected videos, so each complexity is related to an output bitrate. Last, a curve fitting is conducted to all complexity-to-bitrate data points to approximate the relationship. This process is repeated for different codec types, resolutions and other attributes. The complexity-to-bitrate model is used to determine an output bitrate target for a given input complexity.

FIG. 6 provides an empirical relationship, B=func(X_PRED), labeled 600 between the complexity queue 402 and the bitrate queue 502 that is used to control the primary encoder 100 from the decoder 200. This different empirical model is used in the case where the decoder 200 statistics are used directly, rather an using a lookahead encoder, to generate an output bitrate target. This model using the function 600 can be empirical, a lookup table or a mathematical model and will take into account the input and output bitrates, codec types and other parameters. Alternatively, after the complexity is determined from the decoder 200, the complexity value is normalized to a value that would have been produced had a lookahead encoder been available using a function for conversion. The complexity normalization model is developed through an experimental process. First, numerous videos of different contents that cover all levels of complexities are selected. Each video is then encoded using many different bitrates and the same pre-determined bitrate that is used in the lookahead encoder. All complexity-to-bitrate data points are plotted and a curve fitting is conducted to all the data points to approximate the relationship between them. The relationship can be used to convert from the complexity of the input video at a different bitrate to a complexity that would have been produced if a lookahead encoder were used to encode the same video at the predetermined bitrate. After the normalization, the model relating bitrate to complexity for the lookahead encoder as shown in FIG. 5 can be re-used with the normalized complexity. The use of a model that can be empirical, mathematical or a table look-up that allows the complexity from decoder/look ahead encoder to produce the need parameter for the encoder.

For components shown in the figures, such as the lookahead buffer 102, need parameter model 104, bitrate conversion module 302, or bitrate allocation module 302 components, it is understood that these components can include one or more processors and memory components. The memory can be made from devices will store code that is executable by the processors to perform the methods and form the system processing modules according to the present invention described in the above paragraphs. The memory can be loaded from a computer readable medium, such as a DVD or cloud storage over the internet.

Although the present invention has been described above with particularity, this was merely to teach one of ordinary skill in the art how to make and use the invention. Many additional modifications will fall within the scope of the invention as that scope is defined by the following claims.

What is claimed:

1. A dual pass encoding system comprising:
a primary encoder receiving raw video frames from the system input and providing a compressed video output;
a lookahead encoder receiving the raw video frames provided to the input to the primary encoder;
a need parameter model module that receives a complexity value output from the lookahead encoder, maps the complexity to a need parameter value, and provides the need parameter value to the primary encoder.

2. The dual pass encoding system of claim 1, wherein the complexity value output from the lookahead encoder is a complexity estimation based on at least one of: spatial detail measurements, correlation of motion vectors, quantization parameters, number of coded bits, color detail and buffer fullness.

3. The dual pass encoding system of claim 1, wherein the need parameter is a target bitrate that is mapped using the need parameter module from the complexity value.

4. The dual pass encoding system of claim 1, further comprising:
a complexity calculation module provided in the lookahead buffer that provides a complexity calculation to determine the complexity value provided from the output of the lookahead buffer;
a delay buffer providing the raw video frames to the primary encoder input;
a complexity queue buffer provided in the need parameter model module that receives the complexity value from the complexity calculation module; and
a bit rate module that calculates the bit rate from the complexity values from the complexity queue and provides the need parameter as a target bitrate to the primary encoder.

5. A dual pass encoding system comprising:
a decoder receiving a compressed video input;
a primary encoder receiving raw video frames from the output of the decoder, the primary encoder providing a compressed video output;
a lookahead encoder receiving the raw video frames provided from the output of the decoder; and
a need parameter model module that receives a complexity value output from the lookahead encoder, maps the complexity to a need parameter value, and provides the need parameter value to the primary encoder.

6. The dual pass encoding system of claim 5, wherein the need parameter module comprises:
a complexity queue buffer having an input connected to receive the complexity value output from the look ahead encoder and having an output;
a function module receiving the output of the complexity queue buffer and calculating the target bit rate as a need parameter; and
a bitrate queue buffer having an input connected to receive the function module output and having an output providing the need parameter value to the primary encoder.

7. The dual pass encoder of claim 6, wherein the function module calculates the target bit rate by:
selecting numerous videos of different contents that cover different levels of complexities;
first encoding the numerous videos using a pre-determined bitrate;
determining the complexities of the numerous first encoded videos;
second encoding the videos at various bitrates ranging from low to high;
providing the second encoded videos to a group of viewers for a determination from the viewers of video quality;
selecting the lowest bitrate that delivers quality over a predetermined quality threshold as determined from the viewer determinations for each different video so that each complexity has an assigned bitrate mapped; and
determining a curve from points of the mapping of complexity to bitrate to establish the target bitrates for the function module.

8. A transcoding system comprising:
a decoder receiving a compressed video input;
a encoder receiving raw video frames from the output of the decoder, the encoder providing a compressed video output;
a complexity normalization module receiving a complexity value output from an output of the decoder;
a need parameter model module that a normalized complexity value output from the complexity normalization module, maps the complexity to a need parameter value, and provides the need parameter value as a first bitrate output value; and
a bitrate conversion module receiving the first bitrate from the need parameter module and converting to a second bitrate to provide to the encoder.

9. The transcoding system of claim 8, wherein the complexity normalization module determines an output by:
selecting numerous videos of different contents that cover different levels of complexities;
first encoding the numerous videos using a pre-determined bitrate;
determining the complexities of the numerous first encoded videos;
second encoding the videos at various bitrates;
plotting for each different video a complexity to bitrate used in the second encoding to form a mapping of complexity to bitrate; and
determining from a curve of the plotting the normalized complexity output from the video received.

10. The transcoding system of claim 8, further comprising:
a complexity queue buffer having an input connected to receive the complexity value output from the look ahead encoder and having an output;
a function module receiving the output of the complexity queue buffer and calculating the target bit rate as a need parameter; and
a bitrate queue buffer having an input connected to receive the target bit rates from the function module and having an output providing the need parameter value to the encoder.

11. The transcoding system of claim 10, wherein the function module calculates the target bit rate by:
selecting numerous videos of different contents that cover different levels of complexities;
first encoding the numerous videos using a pre-determined bitrate;
determining the complexities of the numerous first encoded videos;
second encoding the videos at various bitrates ranging from low to high;
providing the second encoded videos to a group of viewers for a determination from the viewers of video quality;
selecting the lowest bitrate that delivers quality over a predetermined quality threshold as determined from the viewer determinations for each different video so that each complexity has an assigned bitrate mapped; and
determining a curve from points of the mapping of complexity to bitrate to establish the target bitrates for the function module.

12. A transcoding system comprising:
a decoder receiving a compressed video input;
a complexity queue buffer having an input connected to receive the output from the primary encoder and having an output;
a function module receiving the output of the complexity queue buffer and calculating the target bit rate as a need parameter; and
a bitrate queue buffer having an input connected to receive the target bit rates from the function module and having an output; and
an encoder receiving raw video frames from the output of the decoder, the encoder providing a compressed video output, and the receiving the need parameter values from the bitrate queue buffer.

13. The transcoding system of claim 12, further comprising:
a complexity normalization module receiving a complexity value output from an output of the decoder and provides a normalized complexity value to the input of the complexity queue buffer, wherein the complexity normalization module determines an output by:
selecting numerous videos of different contents that cover different levels of complexities;
first encoding the numerous videos using a pre-determined bitrate;
determining the complexities of the numerous first encoded videos;
second encoding the videos at various bitrates;
plotting for each different video a complexity to bitrate used in the second encoding to form a mapping of complexity to bitrate; and
determining from a curve of the plotting the normalized complexity output from the video received.

14. The transcoding system of claim 12, wherein the function module calculates the target bit rate by:
selecting numerous videos of different contents that cover different levels of complexities;
first encoding the numerous videos using a pre-determined bitrate;
determining the complexities of the numerous first encoded videos;
second encoding the videos at various bitrates ranging from low to high;
providing the second encoded videos to a group of viewers for a determination from the viewers of video quality;
selecting the lowest bitrate that delivers quality over a predetermined quality threshold as determined from the viewer determinations for each different video so that each complexity has an assigned bitrate mapped; and
determining a curve from points of the mapping of complexity to bitrate to establish the target bitrates for the function module.
